(19) United States
(12) Patent Application Publication
(10) Pub. No.: US 2022/0024067 A1
(43) Pub. Date: Jan. 27, 2022

(54) CLOG RESISTANT PRINT HEAD METHOD FOR HIGH SPEED CEMENTITIOUS MATERIAL 3D PRINTING

(71) Applicants: Ahmed Murgab Mohammed Mahil, Melbourne (AU); Michael Stanley, Melbourne (AU); Ming Yan Godfrey Keung, Melbourne (AU); Shaun Heap, Melbourne (AU)

(72) Inventors: Ahmed Murgab Mohammed Mahil, Melbourne (AU); Michael Stanley, Melbourne (AU); Ming Yan Godfrey Keung, Melbourne (AU); Shaun Heap, Melbourne (AU)

(21) Appl. No.: 16/938,980

(22) Filed: Jul. 26, 2020

(51) Int. Cl. B28B 1/00; B33Y 30/00; E04G 21/04

(52) U.S. Cl. CPC B28B 1/001; E04B 1/16; E04G 21/0418; B33Y 30/00

(57) ABSTRACT

An Advanced Additive Construction device to extrude layers of cementitious material consistently and accurately with an anti-clogging method is disclosed. The device introduces low continuous frequency sonic vibrations with frequency range of 20- to 10000 Hz to slow cement or binding agents from curing the mixture inside the extruder and to get rid of air bubbles trapped in the mixture. Buildup of early cured mixtures inside the extruder tract especially in large volume or long period prints result in accumulation of material inside the extruder tract which causes extruder clogging. A shaker plate coupled with four miniature shakers excite the material mixture inside the extruder orthogonal to the inner casing direction. Furthermore, four more miniature shakers equipped with extension rods excite the material mixture inside the extruder orthogonal to the top mount, thereby preventing any cementitious material sticking within the extruder casing and around the central flight auger. Moreover, increasing the print speed and flow rate of the extruder by 60% which results in cutting the print time to more than 70% when counting the elimination of clogging. Also, it allows the extruder to accommodate a wider range of cementitious mixtures without the need to adjust admixtures and setting times especially for mixtures that have a rapid setting rate. The shaker's vibrating system, FIG. 7, functions within the upper chamber of the extruder casing, the upper chamber has the largest diameter as it operates as a flow control reservoir, which has less pressure compared to the lower chamber of the extruder. The vibrating rods and inner wall system prevent cementitious material from sticking to the extruder inner walls and allows smooth continuous flow of material.

### BACKGROUND OF THE INVENTION

### 1. Field of the Invention

The invention related to the field of 3D cementitious material printing, particularly to 3D cement extruder based printers, devices and methods, herein the novel extruder device provides a method that prevents clogging stemming from cementitious mixtures (used interchangeably with the words ‘cement’ and ‘material’ hereby after), curing inside the extruder via introducing vibrations through sonic mini shakers. The introduced vibrations will also serve as a means of increasing the speed of printing.

### 2. Background

3D printing cementitious material generally is a continuous process that has many challenges. One such challenge is that cementitious mixtures cure early and accumulate on the inside of the extruder head due to the limited motion within traditional flight auger driven extruders, where the movement of cement depends on the feed from a pump and the flight auger displacement of material. The accumulated cement build-up will significantly lower the quality of the extrusion; reduce the productivity and eventually clogging and stopping the print.

The quality of the extrusion is reduced because the reduction in flow rate of the outgoing cement causes inconsistent extrusion rate and thus create gaps and discontinuity in the print, also, pieces of early cured cement may get between the layers and introduce structural defects in the final print and thus change the mechanical properties of the structure.

The productivity and efficiency of the technology is therefore significantly affected because the extruder head requires a more frequent maintenance schedule to keep it clean inside, the wastage of cured cement added a layer of cost to the operation. All of these increase the print time and affect the structural integrity of the printed profile.

Traditionally, cementitious materials mixers have a constant motion to keep its content moving to prevent them from curing before being poured into a form. After pouring the material in the form depending on its profile, the mixture is shacked either by a shaking table, or manually by tapping at the form with a mallet. In cementitious 3D printing, it has been a challenge to introduce a distributed motion to cement content inside a confined sealed space such as the extruder head for 3D printing while isolating the induced vibration from the rest of the system effectively.

Inducing external movement to the cement to keep it from curing often introduces undesirable vibrations or noise to the rest of the mechanical system, which makes precise motion control a serious difficulty and, in some cases, impossible without stopping the print at periods. It would be highly desired to introduce controlled vibrations that keeps the cement from curing and at the same time isolate the introduced vibration from the rest of the system.

Different cementitious material mixtures have different setting times, often for materials that set rapidly the printer speed is vital to obtain a sound print. The mixture rapid curing will cause flight auger-based extruders to clog, as the mixture starts to gradually create layers of cured mixture inside the casing, which hinders the print process and requires continuous maintenance throughout the print.

Accordingly, there is a need for an effective anti-clogging system to ensure the productivity, speed, efficiency, and quality of 3D cement printing technology. Specifically, a system that enhances the material flow rate and accommodates different material setting times which will consequently increase the printer's versatility.

### BRIEF SUMMARY OF THE INVENTION

The above deficiencies and other problems associated with cement curing inside the extruder head are reduced or eliminated by the disclosed invention that consists of evenly distributed vibration modules mounted on the top section of the extruder head where movement of the cement is slow or non-existent especially towards the edges of the extruder casing.

The problem with undesirable motion introduced by the vibration is reduced to an insignificant level by the inclusion of decouplers that allow the vibration modules to induce movement to the cement with minimal force transmission to the rest of the extruder head. Thus, it doesn't affect the motion control systems of printers.

The invention is intended to use sonic vibrations to keep the cement in motion and prevent curing as well as getting rid of air bubbles within the mixture, while keeping the rest of the extruder head isolated from the induced vibration and resulting displacement, thus allowing precise motion control of the extruder print head for quality 3D printing.

The induced vibration increases the print speed through exciting the mixture particles; also, the flow rate is not hindered by clogs or build-up inside the extrusion tract. Therefore, the extruder efficiency increases print speed and productivity. Different vibrations based on the materials setting time are implemented to achieve desired speed of the print.

### BRIEF DESCRIPTION OF THE SEVERAL VIEWS OF THE DRAWINGS

FIG. 1 Isometric view of the final assembly of the extruder

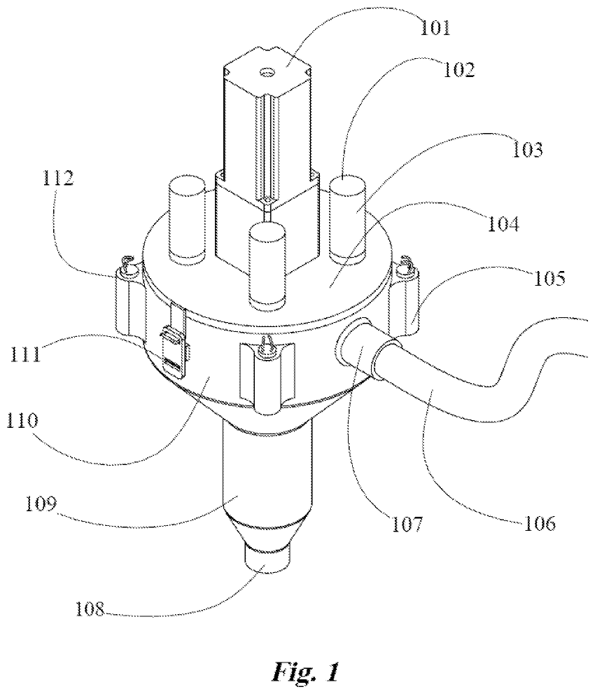

FIG. 2 Wireframe view of the extruder assembly without the feeding duct, central flight auger and auger motor module

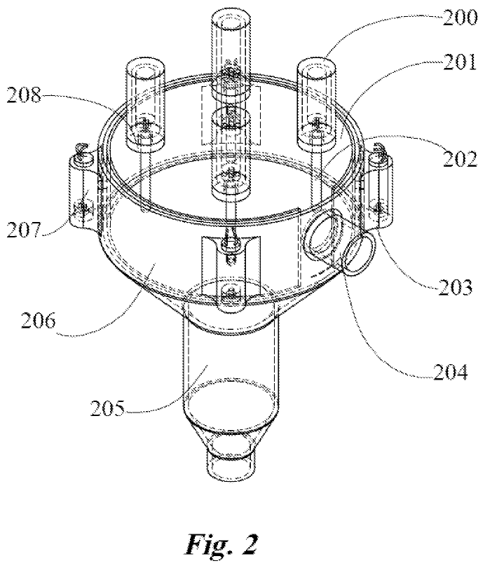

FIG. 3 Cross sectional view of the extruder assembly

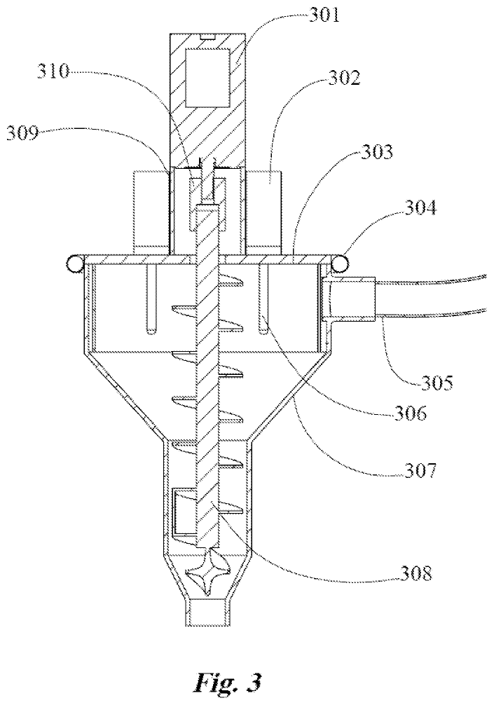

FIG. 4 Outer view of the extruder assembly

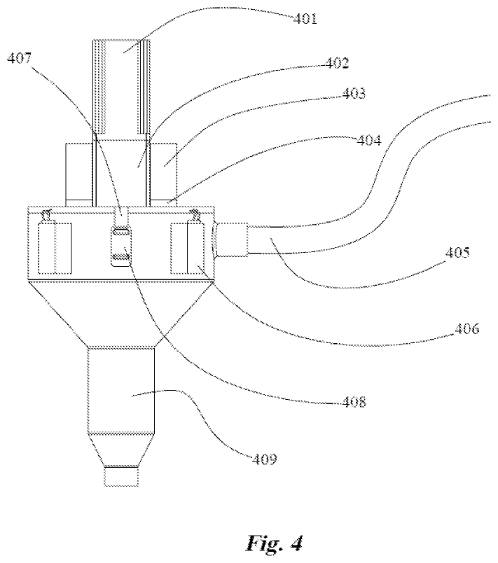

FIG. 5 Wireframe view of the complete extruder assembly

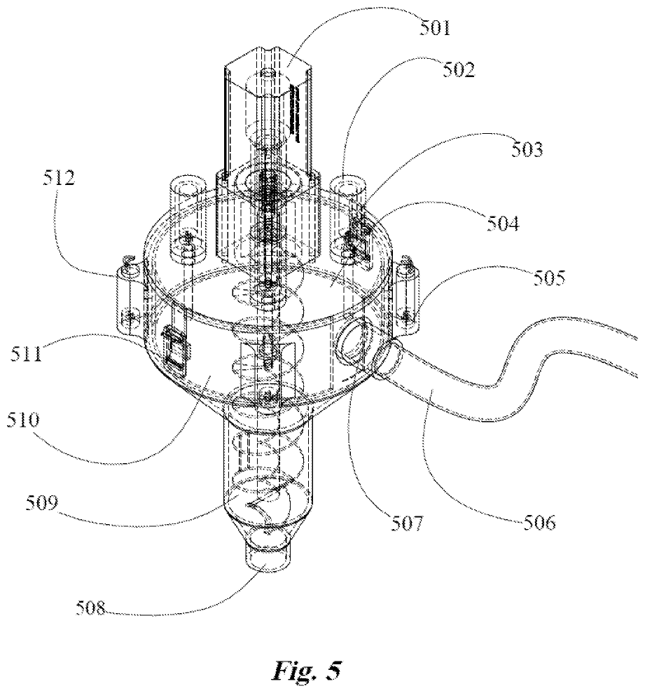

FIG. 6 Cross sectional view of the extruder assembly highlights the vibration system

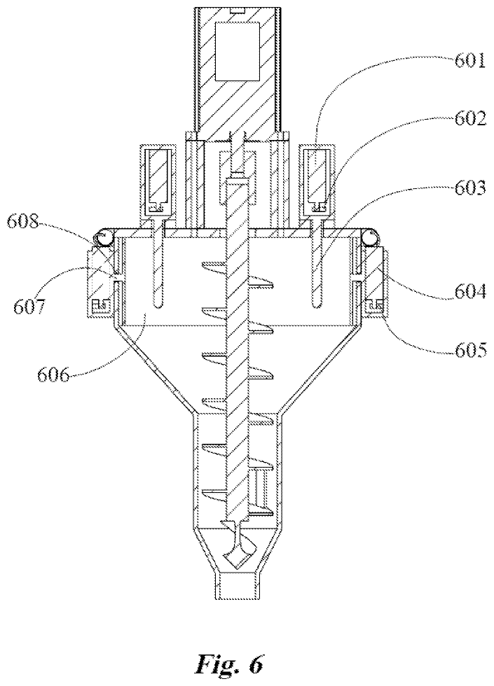

FIG. 7 Component concerning the vibration system.

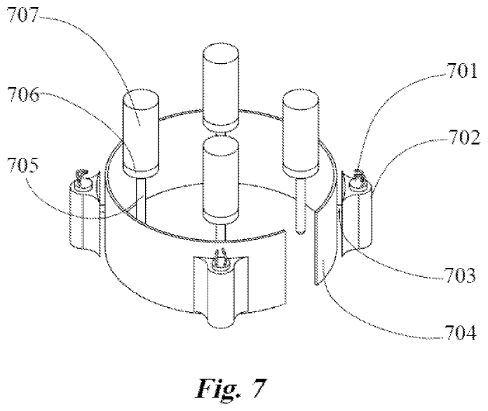

### DETAILED DESCRIPTION OF THE INVENTION

In the following detailed description, numerous specific details are set forth in order to provide a thorough understanding of the present invention. Well-known methods, procedures, components and skills will not be described in detail.

The described extruder is a single assembly with one opening 507 on the side with an interface 107,204 for a standard material feeding duct/hose 106,305,405,506. The cable for the electric components on the extruder may be bundled with the material feeding duct/hose 106,305,405,506. The extruder may be mounted on a robotic arm, slider, gantry crane, or any other mobile platform. The extruder is designed for cementitious 3D printing; it may be used for structural, artistic, agricultural and other purposes.

The design of the extruder has a series of gradually reducing conduits with transitioning cones 307. That helps in compressing the material and allows the upper chamber 110,206,510 to operate as a reservoir, and then the material is compressed through the cone 307 to the lower conduit 109,205,409,509 for a more consistent flow rate and uniform quality.

A tube for cable routing 304 around the top extruder mounting plate 104,303 allows better wire management and reduces the chance of failure caused by tripping on loose cable. It is also a housing to protect the cable from external hazards during operation, deployment, handling, transportation and storage.

The central flight auger 308,504 is the main driving mechanism to transfer the cement from the upper chamber 110,206,510 to the lower conduit 109,205,409,509 then out the extruder nozzle 108,508. The motor module 101,301,401,501 driving the central flight auger 308,504 is controlled by an electronics device that adjusts the speed and torque for better quality extrusion given the mixture mechanical properties.

The motor module 101,301,401,501 is mounted to the top plate 104,303 of the extruder with a supporting structure 309,402 that houses the coupler 310 connecting the central flight auger 308,504 to the motor shaft. The supporting structure 309,402 is designed and sealed to protect its content against intrusion, dust, accidental contact, and water.

The top mounting plate 104,303 also accommodates the four shakers 302,403,601,707 used to introduce the vibration inside the enclosure and keep the cement inside the extruder from curing, which will be elaborated in the next paragraphs. The mounts 208,404,706 for shakers are made viable for easier and quicker assembly. The top plate 104,303 is secured to the extruder casing with toggle lock mechanisms 111,511 placed around the top of the extruder casing. The locking latch 407 is toggled by a mechanical trigger 408.

The four shakers 302,403,601,707 around the auger 308,504 on the top mount of the extruder 104,303 and the four shakers 105,202,604,701 on the outer wall of the upper chamber 110,206,510 are proposed to introduce vibration in the cementitious material flowing from a hose connected to the upper chamber 110,206,510 the shakers' vibrations will get rid of the air bubbles trapped within the material mixture and this prevents material's early curing, furthermore the vibrations will ease the sliding of materials downwards from the upper chamber 110,206,510 inner walls, for a long period of operation which is expected in the application of 3D printing such as structural and civil projects. This principal could also be used for cementitious material with faster curing time.

Each top shaker 302,403,601,707 comprises a casing 102, an actuation source 103, an extension rod 203,306,603,705. The shaker casing 102 protects its content against intrusion, dust, accidental contact, and water. The actuation source 103 generates vibration with tunable frequency monitored and controlled by additional electronics devices. The extension rod 203,306,603,705 extends from the actuation source to the inside of the extruder's upper chamber 110,206,510 near the inner wall 201,606,704 and transmits the perturbations to the cementitious material in the region where movement is slow. The shakers 302,403,601,707 are placed evenly across the top region of the upper chamber so that the introduced vibration is spreaded out to cover a larger effective area. The decoupler 602 served the purpose of isolating the vibrations of each shaker from the rest of the extruder. The shaker induces movement only to the cement mixture inside the extruder via the extension rod 203,306,603,705, and not the rest of the system. The vibration induced by the shaker has minimal effect on the motion of the extruder head. The control of the extruder is free of the noise induced by the added vibration.

The shakers at the casing outer circumference 105,202,604,701 are joined with an inner plate 201,606,704 inside the upper chamber 110,206,510. These shakers are mounted 112,512 on the outer circumference of the extruder's upper chamber110,206,510 casing to isolate their vibrations similar to the top shakers. The connection 607,703 will transmit the vibrations to the inside of the upper chamber 201,606,704 where the vibrations prevent cement from curing and accumulating inside the wall, and further remove air bubbles within the material for better flow rate and print quality. These shakers 105,202,604,701 also include decoupler at the connection, at the outer wall of the upper chamber 110,206,510 and thus the rest of the extruder is not influenced by the vibrations.

The induced vibration by the shakers increases the print speed and flow rate of the extruder by 60% in comparison with the extruder performance when the vibrations are not present as the material mixtures are not able to cure inside the casing due to the perturbations. Further, considering the elimination of clogging, the invention also significantly reduces the down time from maintenance, service, and other operational tasks during printing. As a result, the disclosed invention reduced the print time more than 70% overall.

Also, the controllable vibration allows the extruder to accommodate a wider range of cementitious mixtures without the need to chemically adjust the mixtures setting times, especially for mixtures that have a rapid setting rate.

1. An extruder for cementitious material 3D printing, comprising:
a. Motor-driven flight auger for extrusion;
b. An extruder casing body with transitioning cones; and,
c. Vibration modules with decouplers that isolate the vibration from the rest of the system.

2. The vibration modules of claim 1 for the application of:
a. Introduce Sonic perturbations excited via the vibration modules with a frequency range of 20-10000 Hz.
b. The vibrations slow cementitious material curing and hence from clogging the extruder tract for the purpose of 3D printing;
c. Control and tune the translation velocity of materials inside the extruder from the inlet to the outlet; and,
d. Smoother extrusion of materials due to vibrations within extruder inner parts which makes it possess anti-sticking ability where the mixtures will not stick to the inner walls of the extruder casing; and
e. Introducing vibrations to the cementitious material inside the extruder without affecting the overall print head motion via decouplers.
f. Exciting the mixtures increases motion of the mixture particles and thus, the ability to perform high speed extrusion for mixtures with fast setting rate.

3. The integration of and the method of integrating the vibration modules of claim 1 to a flight auger-based extruder for 3D printing, where the induced vibration is:
a. At localised region of the extruder for effective coverage; and,
b. Adjustable for different materials properties, operational environment, and purposes
